(19) United States
(12) Patent Application Publication
(10) Pub. No.: US 2015/0272110 A1
(43) Pub. Date: Oct. 1, 2015

(54) ANIMAL PASTE ATTRACTANT AND METHOD OF USE

(71) Applicant: PURINA ANIMAL NUTRITION LLC, Shoreview, MN (US)

(72) Inventors: Kent J. Lanter, Waterloo, IL (US); Larry Varner, New Braunfels, TX (US)

(73) Assignee: PURINA ANIMAL NUTRITION LLC, Shoreview, MN (US)

(21) Appl. No.: 14/227,803

(22) Filed: Mar. 27, 2014

(51) Int. Cl. A01M 31/06

(52) U.S. Cl. CPC A01M 31/06

(57) ABSTRACT

Disclosed herein is a paste feed composition comprising a food component, a viscosifier, and water, wherein the viscosity of the composition is at least 10,000 centipoise between 20° C. and 50° C. In some embodiments the viscosity of the composition varies less than about 50% between 20° C. and 50° C. Also described herein are articles including the paste feed composition and methods of making the composition. Also disclosed herein is a method of establishing a pattern of returning behavior in a wild or semi-wild ruminant mammal of the family Cervidae using the paste feed composition.

### TECHNICAL FIELD

The present disclosure relates to feeding or attracting animals in the wild, in an enclosure, or in a semi-enclosed area. The present disclosure also relates to providing animals in small enclosures a means of enrichment or entertainment.

### BACKGROUND

People rely on various methods to modify the behavior of an animal or group of animals. In attracting deer, wild boar or pigs, game birds, or other wild animals to a particular spot in an open area, enclosed area, or semi-enclosed area, for example, people often seek to establish a pattern of behavior where the animal is conditioned to return to the selected spot by providing an attractive scent or airborne compound, a desirable item, or both for one or more animals in a selected location on a repeated basis. The one or more animals become conditioned to return to the spot to obtain the item, or because of the attractive scent or airborne compound. Common attractive items people employ for conditioning purposes include, for example, salt licks for deer, nesting materials for birds, pheromone, urine, or estrous odors provided by sprays and the like, and food.

Food attractants are among the most commonly employed items for attracting wild animals to a selected location. For many species, food attractants are the most successful known means to attract a targeted animal. However, due to the success of this approach, the food usually must be replenished with high frequency, because many animals may visit the selected site and quickly deplete the offered food. Unless the attractant is present over a sufficient percent of time, for example during a period of days or weeks, the animal will not learn to return to see if more food is available. The percent of time or frequency with which the attractant must be present in order for an animal to learn to return is different for animal breeds.

Once the learned behavior is started it is often desirable to maintain the behavior for an additional length of time. The established frequency of replenishing the selected attractant must be maintained during the entire duration.

In the case of certain animals, such as deer, food is a highly successful attractant, particularly in the winter months when food sources for the deer become less plentiful, or in areas of high population density. While food attractants work very well to modify deer behavior and condition the deer to return to a selected spot, food attractants are also depleted very quickly by deer in many cases. Thus, a person hoping to condition deer to return to a selected location to receive food must provide replenishment as frequently as once a day, or even more often depending on how much is food is provided at each replenishment and the number of animals that are attracted.

It is desirable to employ food attractants that are capable of greater longevity in the field, so that they remain available to the targeted animal for longer periods of time between replenishment. It is desirable to employ food attractants that remain located where they are applied outdoors, and further wherein animals cannot carry off any food material from the selected location except by ingesting it. It is desirable to employ food attractants that are not unduly depleted by rain and unaffected in terms of consistency and palatability by temperatures encountered outdoors, including in direct sunlight, winter weather conditions, and the like. It is desirable to provide a food attractant that will condition a type of targeted animal over a large area that is enclosed, semi-enclosed, or unenclosed.

Another form of animal behavior modification is environmental enrichment. Environmental enrichment is the process of providing stimulating environments for animals kept in enclosures, such as cages, zoo enclosures, and the like, in order to enhance their well-being and prevent abnormal or even pathological behaviors in highly intelligent species. Enrichment includes the introduction of objects, smells, and other stimuli in the animal's environment. While food items are one such stimuli, it is difficult to provide food stimuli that will not be depleted too quickly and/or provide the animal with too high a caloric intake if ingested too frequently or in too high an amount on a daily basis. One solution is “puzzle feeders” wherein food is a reward for solving a problem. Such feeders or other toys provide entertainment and satisfy the natural need to forage. Additional materials for providing such stimuli are desirable for animal enrichment purposes.

### SUMMARY

Disclosed herein is a paste feed composition comprising a food attractant, a viscosifier, and water, wherein the viscosity of the composition is at least 10,000 centipoise between 20° C. and 50° C. In some embodiments the viscosity of the composition varies less than about 50% between 20° C. and 50° C. In some embodiments, the viscosifier includes agar, xanthan gum, locust bean gum, a carrageenan, guar gum, or a combination of two or more thereof. In some embodiments the viscosifier is present in the composition at about 0.01 wt % to 3 wt %. In some embodiments the composition includes a sugar-containing product, a grain component, and a plant-derived oil component. In some embodiments the food attractant is soluble or dispersible in the composition. In some embodiments the composition further includes citric acid. In some embodiments the composition further includes one or more pheromones, animal extracts, vitamins, salts, minerals, Maillard reaction products of one or more sugars and proteins, or a combination thereof.

Also disclosed herein is an article comprising the paste feed composition, wherein the article is a tree, a log, a branch, a rock, or a combination of two or more thereof that are present outdoors. In embodiments, the article attracts or enriches a targeted animal for about 1 to 30 days. In some such embodiments, the targeted animal is a wild or semi-wild ruminant mammal of the family Cervidae. In some embodiments, the animal is a captive animal in an enclosure; in some such embodiments the enclosure is in a zoo and the animal is a zoo animal.

Also disclosed herein is a method of making a paste feed composition, the method including mixing one or more food components, viscosifiers, and optional adjuvants with water to form a slurry, heating the slurry, and cooling the slurry to form a paste feed composition. In some embodiments, the method includes mixing a sugar-containing component with water in a vessel to form a sugar containing solution; adding agar, xanthan gum, guar gum, carrageenan, locust bean gum, or a combination thereof to the sugar containing solution to form a slurry; mixing additional food components comprising a grain component and a plant-derived oil component into the slurry; heating the slurry to between 40° C. and 100° C. to form a feed composition; removing the heat source from the feed composition; and pouring the feed composition from the vessel into two or more containers, wherein upon reaching a temperature of about 20° C. to 50° C. the feed composition sets up to form a paste feed composition having a viscosity of about 10,000 centipoise to 5,000,000 centipoise. In some embodiments, pouring the slurry into the two or more containers is carried out prior to the heating. In other embodiments, pouring the composition into the two or more containers is carried out after removing from the heat source but prior to set up.

Also disclosed herein is a method of establishing a pattern of returning behavior in a wild or semi-wild ruminant mammal of the family Cervidae, the method including applying a paste feed composition to one or more selected surfaces within a selected location, wherein 1 to 1000 animals are attracted to the selected location having the paste feed composition applied thereto. In some embodiments, the paste feed composition is applied to the one or more selected surfaces between 1 and 5 times. In some embodiments, the selected location comprises between 2 and 100 selected surfaces. In some embodiments, the selected location is an open, semi-enclosed, or large enclosed area. In some embodiments, the animals are attracted to the selected location for about 1 to 30 days after an application of the paste feed composition.

Also disclosed herein is a method of providing enrichment for an animal in an enclosure, the method including introducing an article into the enclosure, the article including a puzzle feeder, a toy, hay or a hay stack, woven or nonwoven fabric, a stick, wood fibers, plastic netting or mesh, a tree, a log, a branch, a rock, or a combination of two or more thereof, wherein the article includes a composition including a food attractant, a viscosifier, and water, wherein the viscosity of the composition is at least 10,000 centipoise between 20° C. and 50° C. The article is replenished in some embodiments after 1 to 30 days.

Additional advantages and novel features of the invention will be set forth in part in the description that follows, and in part will become apparent to those skilled in the art upon examination of the following, or may be learned through routine experimentation upon practice of the invention.

### DETAILED DESCRIPTION

Overview

Various embodiments will be described in detail. Reference to various embodiments does not limit the scope of the claims attached hereto. Additionally, any examples provided herein are not intended to be limiting and merely set forth some of the many possible embodiments for the appended claims.

As used herein, the term “about” modifying, for example, the quantity of an ingredient in a composition, concentration, volume, process temperature, process time, yield, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

The paste feed compositions of the invention have several advantages for attracting wild animals in an open, semi-enclosed, or large enclosed areas and for establishing a pattern of behavior wherein one or more animals are conditioned to return to the selected spot. The paste feed compositions are easy to make and transport, and easy for an end user to apply. The paste feed compositions are easily applied to a variety of surfaces and after application do not run, drip, sag, or otherwise flow. The paste feed compositions are not quickly depleted by rain. The paste feed compositions are not vulnerable to temperatures encountered in outdoor applications, and remain paste-like in both high temperature and low temperature environments. The paste feed compositions are easily applied to uneven surfaces having crevices, cracks, convolutions, folds, and the like and thus are difficult for an animal to deplete fully. The interplay between the robust viscosity of the paste-like feed compositions and its placement in hard-to-reach locations provides a food attractant with longevity to act as an effective attractant for a targeted animal for days, up to several weeks without replenishment.

The paste feed composition can include a number of food components suitable for a range of targeted animals. In general, food components that the animal finds palatable, wherein individual food items are smaller in size than about 2 cm in any one dimension are suitably employed in the feed compositions. In embodiments, the food components are particulate or flake-like in nature, having particle sizes of 5 mm or less in the largest direction or less, or about 1 mm or less in the largest direction. In some such embodiments, for example, the food components have particle sizes of about 5 mm to 1 μm, or about 3 mm to 5 μm, or about 1 mm to 5 μm mm in the largest direction, wherein the target animal cannot pick the food item out of the composition and carry it away. In some such embodiments, the food components are soluble or dispersible in the composition, wherein the individual portions thereof cannot be separated from the paste feed composition by the animal.

The paste feed compositions have a paste-like viscosity that is provided, in embodiments, by blending the food components with one or more viscosifiers and water. In embodiments, the viscosifiers are activated by heat; in such embodiments, all components are suitably blended in a low viscosity mixture, and then the mixture is heated to provide the targeted paste-like viscosity, also referred to herein as “set up”. In some embodiments, heating is followed by cooling before set up is observed.

Composition

The paste feed compositions of the invention include at least a food component, water, and a viscosifying additive, or viscosifier. Food components are employed in a wide variety of combinations that are not particularly limited by their recitation herein; it will be appreciated by those having skill that food components are selected for attracting the targeted species of animal for behavior modification. As such, any known combination of food components known to the palatable or attractive to the animal is suitably employed in the paste feed compositions of the invention.

One suitable food component is a sugar-containing product such as molasses, honey, sugarcane, sugar beet, fruit extracts, and the like, and combinations of two or more thereof. Where employed, the total amount of sugar-containing components generally ranges from about 10 wt % to 90 wt % of the composition. In some embodiments the sugar-containing component is present at about 10 wt % to 85 wt % based on the total weight of the composition, or about 15 wt % to 80 wt %, or about 20 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 10 wt % to 90 wt % in 1 wt % increments (such as 16 wt % to 23 wt %, 54 wt % to 75 wt %, and the like).

Another suitable food component is a C3-C7 sugar or sugar alcohol and combinations of these. Examples of suitable sugars include fructose, glucose, galactose, sucrose, maltose, and lactose, or two or more thereof. Examples of suitable sugar alcohols include adonitol, allitol, altritol, arabinitol, dulcitol, erythritol, galaxitol, glucitol, sorbitol, glycerol, iditol, inositol, isomalt, lactitol, maltitol, mannitol, perseitol, ribitol, rhamnitol, threitol, and xylitol or two or more thereof. Combinations of various sugar-containing products, sugars, and sugar alcohols are suitably employed as food components in the paste feed compositions. Where employed in a paste feed composition, a C3-C7 sugar, a sugar alcohol, or combination thereof is present at a total amount of about 1 wt % to 80 wt % based on the total weight of the composition, or about 5 wt % to 75 wt %, or about 10 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 1 wt % to 80 wt % in 1 wt % increments (such as 6 wt % to 23 wt %, 74 wt % to 75 wt %, and the like).

Another suitable food component is whole or ground grain or grain components, such as bran, from natural or genetically engineered grains including amaranth, barley, buckwheat, bulgur, corn, einkom, farro, grano, khorasan grain, kaniwa, millet, oats, quinoa, rice, rye, sorghum, spelt, triticale, wheat (including durum wheat, and bread wheat including hard wheat, soft wheat, white wheat, red wheat, winter wheat, and spring wheat), and wild rice. Where employed in paste feed compositions, the total amount of whole grain, ground grain, or a grain components is present at a total amount of about 5 wt % to 50 wt % of the edible composition, or about 10 wt % to 50 wt %, or about 10 wt % to 40 wt %, or about 15 wt % to 30 wt %, or about 20 wt % to 30 wt % of the total weight of the foaming feed composition, or any compositional amount within the range of 5 wt % to 50 wt % in 1 wt % increments (such as 6 wt % to 8 wt %, 16 wt % to 52 wt %, and the like).

Another suitable food component is a legume or component thereof, such as the oil thereof; examples of legumes include peanuts, chickpeas, various common strains of beans and peas, fava beans, lentils, lima beans, lupins, mung beans, pigeon peas, runner beans, and soybeans as well as combinations of two or more thereof.

Another suitable food component is a seed or seed extract; examples of suitable seeds include flax seed, safflower seed, sunflower seed, rapeseed including canola, and the like; a commonly employed extract of such seeds is the oil thereof; combinations of two or more seeds, seed extracts, or both are also usefully employed.

Another suitable food component is a plant-derived oil including a vegetable oil, such as palm oil, cottonseed oil, palm kernel oil, olive oil, and oil as a component extracted from any of the grains, legumes, or seeds listed above. Where employed in paste feed compositions, the total amount of plant-based oil generally ranges from about 0.1 wt % to 10 wt % of the total weight of the composition, or about 0.25 wt % to 9 wt %, or about 0.25 wt % to 8 wt %, or about 0.25 wt % to 7 wt %, or about 0.25 wt % to 6 wt %, or about 0.50 wt % to 6 wt %, or about 0. 50 wt % to 5 wt %, or about 0.50 wt % to 4 wt %, or about 0.50 wt % to 3 wt % based on the total weight of the foaming feed composition, or any compositional amount within the range of 0.1 wt % to 10 wt % in 0.1 wt % increments (such as 0.3 wt % to 9.7 wt %, 2.6 wt % to 2.7 wt %, and the like).

Another suitable food component is a mineral. Useful minerals included in the paste feed compositions include such compounds as monocalcium phosphate, dicalcium phosphate, calcium carbonate, sodium carbonate, sodium bicarbonate, sodium chloride, potassium chloride, potassium carbonate, potassium iodate, magnesium oxide, ferric oxide, ferrous oxide, calcium oxide, calcium hydroxide, chromic oxide, copper oxide, copper sulfate, zinc oxide, calcium chloride, copper sulfate, trace amounts of selenium, chromium, cobalt, molybdenum, manganese, fluoride, iodine, and the like, and vitamin supplements such as vitamin A, K, D, D3, various B vitamins, or E supplements.

Useful viscosifiers for forming the paste feed compositions include any known food-safe viscosifiers. In some embodiments, two or more viscosifiers are employed in combination, particularly where a combination of properties is desirable. Suitable viscosifiers include gums, starches, inorganic colloids such as certain clays, and plant-based thickeners commonly employed in food. Examples of suitable viscosifiers include xanthan gum, locust bean gum, agar, carrageenan, alginic acid, sodium alginate, gum Arabic, gum ghatti, gum tragacanth, karaya gum, guar gum, chicle gum, dammar gum, glucomannan, psyllium seek husks, spruce gum, tara gum, gellan gum, arrowroot, corn starch, β-glucan, various types of cellulose or methyl cellulose, pectin, potato starch, gelatin, chondrin, press cake from Irvingia gabonensis, gum karaya, gulaman, montmorillonite clays, bentonite clays, attapulgite clays, and the like. In some embodiments, the viscosifier is a blend of two or more of these or a blend of these with additional additives known to interact with the viscosifier(s) to increase viscosity further or affect other properties in a manner that is advantageous for the paste feed compositions.

In some embodiments, the selected viscosifier exhibits hysteresis. One example of a viscosifier that exhibits hysteresis is agar. Agar is a phycocolloid extracted from a group of red-purple marine algae (class Rhodophyceae) including Gelidium, Pterocladia and Gracilaria. Impurities, debris, minerals and pigment are reduced to specified levels during manufacture. Agarose, the gelling fraction of agar, is a neutral linear molecule consisting of chains of repeating alternate units of β-1,3-linked D-galactose and α-1,4-linked 3,6-anhydro-L-galactose. Agar is available in powder, flake, thread, and bar form. Dissolved at 1%-2% w/v in boiling water, agar forms a transparent, firm, shear resistant gelatinous medium upon subsequently reaching 32° C.-40° C. However, once solidified, the agar does not “melt” or become re-liquefied at 32° C.-40° C. Rather, the gelled agar must be reheated to about 8° C. (185° F.) in order to liquefy. Some softening may occur starting at about 65° C. (149° F.). The phenomenon wherein a gelled mass melts, or liquefies, at a different temperature from that at which it solidifies is known as hysteresis.

The solidification and subsequent hysteresis behavior of agar, as an illustrative example, is useful in embodiments of the paste feed composition. First, as will be discussed below, it is useful to form a slurry including at least water, one or more food components, and viscosifier at e.g. ambient temperatures wherein the viscosity does not immediately begin to build on account of the viscosifier addition. This allows for ease of mixing and packaging, in some cases including masterbatch formation and transportation or storage, followed by heating at a selected time to trigger increased viscosity. This is discussed in detail below. Second, the “set up” temperature of 32° C.-40° C., where the agar becomes gelled after heating, is advantageous, wherein the heated slurry can be packaged while at an elevated temperature and prior to “set up” to form the paste feed composition, wherein the paste feed composition is at the final selected viscosity. Third, the hysteresis agar is of critical importance for outdoor use, particularly in warm weather. It is the hysteresis that prevents the paste feed composition from sagging, dripping, running, or flowing off of the selected location where the paste feed composition is placed, for example at temperatures near 40° C., in direct sunlight, or both. For the purposes of the paste feed compositions of the invention, hysteresis is important for viscosifiers that have an initial set up temperature that is below temperatures encountered in outdoor use. Whether or not such viscosifiers require an initial heating step to provide set up, it is important for end use that the paste feed compositions do not liquefy at temperatures encountered in natural conditions encountered in outdoor use. Where applied on a horizontal surface facing direct sunlight on a hot, summer day, for example, the paste feed compositions could encounter temperatures as high as 50° C., thus it is critical that the paste feed compositions retain peak viscosity at least to this temperature.

In various embodiments, the viscosity, shear resistance, or hysteresis behavior of the viscosifier is affected by concentration of the viscosifier, time, pH, and content of sugar or other food component of the paste feed composition. Again, as an illustrative example, the pH noticeably affects the strength of the agar gel; as the pH decreases, the gel strength weakens. Sugar content has also a considerable effect over agar gel. Increasing levels of sugar make gels with agar into harder gel structures. Thus, where agar is employed as the viscosifier, it is desirable to maintain pH in a neutral zone, at about 4.5 to 9, and balance the inclusion of sugar, if any, with the amount of agar to form a gel having the desired rheological profile.

In some embodiments, the viscosifier exhibits pseudoplastic behavior. One example of a viscosifier that exhibits pseudoplastic behavior is xanthan gum. Xanthan gum is a bacterially synthesized polymer composed of glucose, mannose, and glucuronic acid repeat units in a characteristic 2:2:1 molar ratio, It is produced by the fermentation of glucose, sucrose, or lactose by Xanthomonas campestris. After a fermentation period, the polysaccharide is precipitated from a growth medium with isopropyl alcohol, dried, and ground into a fine powder. The powder is simply added to an aqueous medium to form the gum, wherein swelling occurs slowly over a period of time at ambient temperature. Xanthan gum produces a large increase in the viscosity at very small quantities, on the order of 0.5% or less by weight in water. Xanthan gum also has a characteristic tendency to prevent formation of ice crystals in frozen food compositions, providing a pleasant creamy texture to cold foods, and thus is useful in some embodiments of the paste feed compositions of the invention wherein cold environments, e.g. below 0° C. are expected. The viscosity of xanthan gum solutions decreases with higher shear rates; this is called shear thinning or pseudoplasticity. This means that a product subjected to shear, whether from mixing, shaking or even chewing, will thin out, but once the shear forces are removed, the substance will immediately thicken back up. Unlike many other gums, it is very stable under a wide range of both temperature and pH, notably stable down to pH of 2, and it requires no heat in order to build viscosity. Xanthan gum is easily dispersed in an oil or glycol component, prior to addition of water, and thus may be premixed with one or more food components for ease of mixing and to avoid formation of clumps when water is added to form a slurry.

In some embodiments, one or more of locust bean gum or guar gum are usefully employed as a viscosifier in the paste feed composition. Locust bean gum and guar gum are seed gums produced by removing the outer coating of a seed, and grinding its endosperm. Both locust bean gum and guar are non-ionic galactomannans, that is, polysaccharides including galactose and mannose units. Guar gum has a mannose:galactose ratio of about 2:1 while locust bean gum has a mannose:galactose ratio of about 4:1. Locust bean gum in particular is useful for low temperature applications, for example where the paste feed compositions are employed during winter months in cold climates. Locust bean gum is used in the paste feed compositions at about 0.01 wt % to about 1.0 wt %. In some embodiments, the paste feed composition is slurried with the locust bean gum, then the slurry is heated to at least about 47° C. to dissolve the gum, giving rise to thickening.

In some embodiments, one or more carageenans are usefully employed as viscosifiers in the paste feed compositions. Carageenans are a family of linear, high-molecular-weight sulfated (anionic) polysaccharides that are extracted from red edible seaweeds. The carrageenan polysaccharide chains are made up of galactose and 3,6 anhydrogalactose (3,6-AG) units, sulfated and nonsulfated. Carageenans bind strongly to proteins. There are three main varieties of carrageenan, which differ in their degree of sulfation. Kappa-carrageenan has one sulfate per disaccharide and forms hard, rigid gels in the presence of potassium ions. Iota-carrageenan has two sulfates per disaccharide and forms soft gels in the presence of potassium ions. Lambda-carrageenan has three sulfates per disaccharide and increases viscosity but does not gel. In embodiments, carageenans are used in the thickened foam feed compositions at about 0.01 wt % to about 2.0 wt %. The carageenans have nearly Newtonian rheological properties at the lower concentrations, with shear thinning properties (pseudoplasticity) developing at higher concentrations. In some embodiments, the paste feed composition is slurried with the carageenan, then the slurry is heated to at least about 40° C. to dissolve the gum, for example where potassium or calcium salts of the sulfate groups are employed. In other embodiments, no heat is employed to form the paste feed compositions.

In some embodiments, a combination of viscosifiers is employed in the paste feed compositions. In particular, it is desirable to use two or more viscosifiers to impart desirable properties to the paste feed compositions, such as heat-induced set up and pseudoplasticity; or hysteresis and pseudoplasticity, or partial set up without heat, followed by complete set up with addition of heat, or some other combined set of properties desirably imparted by a blend of viscosifiers. In other embodiments, chemical interactions between viscosifiers lead to higher viscosity, or enhanced elasticity over the same weight of either viscosifier alone. Examples of such blends are xanthan gum with locust bean gum, locust bean gum with agar, carrageenan with locust bean gum, and xanthan gum with guar gum.

Aside from the food component, viscosifier, and water, a number of additives are included in various embodiments of the paste feed compositions of the invention. Preservatives, stabilizers, and adjuvants are suitably included in various embodiments to the paste feed compositions. The additives may be food safe for the selected animal.

Examples of suitable preservatives include sorbic acid, potassium sorbate, fumaric acid, propionic acid, and benzoic acid. Common antimicrobial preservatives include sorbic acid and its salts, benzoic acid and its salts, calcium propionate, sodium nitrite, sulfites (sulfur dioxide, sodium bisulfite, potassium hydrogen sulfite, etc.) and disodium EDTA. Antioxidants include BHA, BHT, TBHQ and propyl gallate. Other preservatives include ethanol and methylchloroisothiazolinone. Naturally occurring substances such as rosemary extract, hops, salt, sugar, vinegar, alcohol, diatomaceous earth and castor oil are also useful as preservatives in some embodiments of the foaming feed compositions. Another group of preservatives targets enzymes in fruits and vegetables that act on these plants after they are cut. For instance, the naturally occurring citric and ascorbic acids in lemon or other citrus juice can inhibit the action of the enzyme phenolase which turns surfaces of cut apples and potatoes brown. Vitamin C and Vitamin E are also sometimes used as preservatives.

Examples of suitable emulsifiers include egg yolk lecithin, mustard seed mucilage, soy lecithin, sodium stearoyl lactylate, and monoglyceride ester of diacetyl tartaric acid.

Examples of suitable stabilizers include those that prevent undesirable interactions within the edible compositions. For example, calcium sequestrants such as tetrasodium pyrophosphate are usefully employed to prevent interaction of calcium ions with other components of the edible compositions, thereby maintaining stability of the compositions.

Examples of suitable adjuvants include attractants such as pheromones and pheromone-containing substances including urine, estrous, and the like or other scents that are known to attract the targeted animal; vegetable or animal extracts that provide enhanced palatability, such as beef extract or fish oil; vitamins, minerals, salts, trace nutrients, or other elements or nutrients beneficial to the targeted animal; other compounds known to increase palatability to the targeted animal. Palatability increasing compounds, or palatants, include citric acid, Maillard reaction products of various sugars and proteins, and the like. In some embodiments, the palatability increasing compounds or some portion thereof can become airborne and thus serve as an airborne attractant to the targeted animal.

In some embodiments, the palatant is citric acid. Sources of citric acid include fruit, fruit portions, or fruit extracts. In some embodiments, the citric acid source is isolated natural or synthetic citric acid provided as a dry powder to the edible compositions. In some embodiments, a combination of fruit, fruit portions, or fruit extracts with isolated citric acid is employed in the paste feed compositions. In various embodiments, the paste feed compositions include a total of about 0.3 wt % to 1.5 wt % citric acid. In some embodiments, the paste feed compositions include about 0.4 wt % to 1.0 wt %, or about 0.5 wt % citric acid, or any compositional amount within the range of 0.3 wt % to 1.5 wt % in 0.05 wt % increments (such as 0.45 wt % to 0.75 wt %, 0.90 wt % to 1.25 wt %, and the like). The availability of isolated citric acid is an advantage of using citric acid as a palatant in the paste feed compositions. Citric acid is generally widely available, and is inexpensive relative to many known flavor additives useful in edible mixtures for ruminants, such as food or attractant mixtures.

Other palatants suitably employed in the paste feed compositions include vegetable or animal extracts, such as beef extract or fish oil; vitamins, minerals, salts, trace nutrients, or other elements or nutrients beneficial to the selected animal; or other compounds or mixtures thereof known to increase palatability to the selected animal. Palatants include Maillard reaction products of various sugars and proteins, and the like. In some embodiments, one or more palatants or a component thereof can become airborne and thus serve as an airborne attractant to the selected animal. For example, it is known by those of skill that Maillard reactions give rise to a complex combination of compounds, some of which become airborne to provide attractive aromas and some of which are flavor compounds that are not volatile.

In some embodiments, the paste feed compositions include compounds or reactive blends of compounds that cause foaming; in such embodiments, the paste feed composition is a foam paste composition. In some embodiments, the foaming agent is combination of citric acid/sodium bicarbonate.

The foam paste compositions provide for the increased amount of attractant aromas or other volatile compounds released from the foam paste compositions by forming gas bubbles that entrain volatile compounds, wherein the burst bubbles then release the molecules into the environment. Food odors or other odors or volatile attractants such as pheromones are advantageously dispersed using the foam paste compositions. In embodiments, effective amounts of one or more attractive odors are dispersed over a larger area due to increased amounts of the odors being released in a selected period of time when compared to feed compositions that do not foam.

The type of foaming agent employed in a foam paste composition is not particularly limited. Suitable foaming agents include propellants, propellants in combination with nucleating agents wherein the nucleating agent is added by the end user to accelerate foam formation, and components employed by end users to initiate two-part foam-forming reactions. In some embodiments the foaming agent is a propellant, wherein the foam paste composition is provided in a pressurized package and, upon the user dispensing the composition onto or into a substrate, the propellant expands and the foam is formed by the expansion. Such packaging and dispensing technologies are well known in the industry and any of the known packaging or dispensing mechanisms employed to provide pressurized propellant-containing liquid compositions is suitably employed in conjunction with the foam paste compositions containing propellant. In some embodiments, the propellant is carbon dioxide or nitrous oxide.

In some embodiments, the foam is formed by a two-part foam-forming reaction. In such embodiments the user combines the contents of a two-part package, or kit, to start the reaction and initiate foaming. In some such embodiments the combining is done at the same time as the dispensing of the foam paste composition. In some such embodiments suitable packaging systems for contemporaneous mixing and dispensing of a two-part system are advantageously employed. In some embodiments the two-part package includes a first part including at least water, a viscosifier, one or more food components, and a first compound that can participate in a gas-forming reaction; a second part includes at least a second compound that can participate in a gas forming reaction with the first compound. In some such embodiments, the second part further includes water, one or more food components, a viscosifier, or two or more thereof.

In various embodiments described below, a two-part mixture that when combined forms an foam paste composition is not a foam paste composition prior to the mixing of the two parts. In such embodiments, one or more parts thereof may be referred to as a “foam paste premix”, wherein in some embodiments the premix contains at least water, a viscosifier, and one or more food components.

In some embodiments, the foam forming chemical reaction is accomplished by a reactive combination that undergoes a reaction to form a gas, and the gas forms the foam in the foam paste composition. The reactive combination includes a first reactive component and second reactive component, wherein the reactive combination is formed by an action taken by an end user. The first reactive component, second reactive component, or both include a single compound or a mixture of two or more compounds. In some embodiments, the first reactive component is present in a foam paste premix, and the user adds the second reactive component to the premix to form the foam paste composition. In such embodiments, the second reactive component can be included as an “activator” in a kit, the kit containing the foam paste premix and the activator, the activator designed and adapted to add to the premix using one of the packaging embodiments and one of the methods of addition and mixing described herein.

In other embodiments, both reactive components are added by the end user to the foam paste premix in order to form the foam paste composition. In some such embodiments, the two reactive components are supplied in two activator packages, as part of a kit that includes the edible foam premix, wherein the reactive components are mixed prior to or contemporaneously with the addition of the mixture to the foam paste premix; in other such embodiments the two reactive components are provided in a single activator package as a mixture, wherein the mixture is triggered to react by dissolution in the water provided in the foam paste premix. For example, in some embodiments an activator is two powdered compounds that undergo an acid-base reaction, wherein the two compounds are safely commingled in a dry mixture, further wherein upon dissolution in water the acid-base reaction is initiated. In another such embodiment, a foam paste premix is a combination of one or more food components and the first reactive component, wherein water, viscosifier, and the second reactive component combined form the activator that is supplied, together with the foam paste premix, in a kit.

Suitable examples of reactive combinations include salts of carbonic acid as one reactive component and a Bronsted-Lowry (protic) acid as the other reactive component, wherein the reaction thereof yields carbon dioxide gas and the salt of the acid. The strength of the acid required to provide the reaction is determined by the particular salt species employed in such reactions. Thus, for example, sodium carbonate or sodium bicarbonate undergo reactions with weak protic acids to yield carbon dioxide and the sodium salt of the acid. Weak protic acids include organic acids such as acetic acid, propionic acid, butyric acid, lactic acid, tannic acid, malic acid, gluconic acid, glycolic acid, pyruvic acid, glutamic acid, fumaric acid, succinic acid, citric acid, isocitric acid, pimelic acid, linear polycarboxylic acids such as oxalic acid, malonic acid, succinic acid, glutaric acid, and adipic acid; and anhydrides that break down into acids on contact with water, such as acetic anhydride, butyric anhydride, malonic anhydride, or succinic anhydride; and combinations of two or more thereof. In various embodiments the carbonate or bicarbonate salt is a lithium, sodium, potassium, magnesium, or calcium salt, or a mixture of two or more thereof. The acid used to liberate carbon dioxide is selected by the user based on reactivity and edibility and/or palatability of the resulting salt that forms in the reaction with the carbonate species.

In some embodiments wherein the first reactive component is present in a foam paste premix and the second reactive component is added to the composition to form the foam paste composition, a carbonate or bicarbonate is the first reactive component and the acid or anhydride is the second reactive component. In other such embodiments, the acid or anhydride is the first reactive component and a carbonate or bicarbonate is the second reactive component. In some embodiments, a bicarbonate or carbonate are provided in one mixture with an anhydride, wherein the mixture is supplied in dry form in a package separate from an foam paste premix that includes at least the water, a viscosifier, and one or more food components.

In some embodiments, the foam paste premixes or foam paste compositions include a total of about 0.3 wt % to 1.5 wt % citric acid for use as a palatant. Citric acid is also usefully employed as a first reactive component, that is, it is added to a foam paste premix, whereas sodium carbonate or sodium bicarbonate is advantageously employed as the second reactive component that is added to the foam paste premix by the end user. In embodiments where citric acid is employed as a reactive component, the amount employed is adjusted to include the stoichiometric amount required to react with a carbonate or bicarbonate, or the stoichiometric amount plus an additional 0.3 wt % to 1.5 wt % based on the weight of the foam paste composition or of the premix.

In one embodiment, citric acid and sodium bicarbonate are provided as the first and second reactive component, respectively, wherein both reactive components are blended in dry form. The foam paste premix includes water, a viscosifier, one or more food components, and optionally additional citric acid. The end user then adds the reactive component blend to the premix in order to start the foaming reaction. In some embodiments, the first reactive component, second reactive component, or both are provided in a slow-release form, wherein the materials are encased within a coated pellet, granule, tablet, and the like. In some embodiments, the coating provided on the pellet, granule, tablet or the like is a water soluble or water swellable polymer, such that the polymer slowly dissolves upon addition of the coated pellet, granule, tablet or the like to an foam paste premix and foaming action is initiated upon contact of the water with the first reactive component, second reactive component, or blend thereof. Such water soluble or swellable coatings are known in the industry and any such coatings are usefully employed herein. In some embodiments, a portion of the first reactive component, second reactive component, or both are provided in a slow-release form, and the remainder of one or more reactive components are provided without a protective coating in order to initiate some amount of immediate foaming upon contact with water or with the other reactive component.

The packaging employed in dispensing a two-part reactive component system is not particularly limited. In some embodiments, the foam paste premix and the activator, together with the packaging thereof, form a kit that is provided to an end user. In some embodiments, the user simply opens two packages and dispenses the contents thereof into a container such as a flask, bottle, or bucket and mixes the contents by hand before applying the foam paste composition to the desired surface. In other embodiments, special packaging is employed to mix the two reactive components within a supplied package prior to dispensing, such as a single package with a perforatable membrane between the parts and a nozzle to dispense the mixed components onto the selected surface. In some embodiments, the dispensing mechanism is a static mixer, such that mixing and dispensing of premix and activator is carried out contemporaneously. In some embodiments, the two part mixture is mixed and the left in the provided package, wherein the foaming reaction and concomitant volume increase of the foam paste composition causes the foam paste composition to move out of the package through an opening adapted for the dispensing.

In some embodiments the foam paste compositions further include one or more foam stabilizers. “Foam stabilization” means to slow the rate of eruption of the bubbles present in the foam, regardless of the mechanism of their formation. “Foam stabilizers” or “foam stabilizing agents” are thus any material or compound that serves to slow bubble eruption of the foam, prolonging foam lifetime. In some embodiments, the foam stabilizer is a nonionic surfactant. Suitable nonionic surfactants include, for example, ethoxylated fatty alcohols, fatty acid alkanolamides, fatty amine oxides, octyl- or nonylphenol ethyoxylates, and sorbitan esters and their ethoxylates such as polyoxyethylene (20) sorbitan monooleate; many others are known and used in the food industry for foam stabilization. In embodiments, the foam stabilizer is a food-safe surfactant or a GRAS surfactant. In some embodiments, the viscosifiers employed to form the paste are also foam stabilizers.

The paste feed compositions of the invention, once set up, have viscosity of at least about 10,000 centipoise (cP) and as high as about 5,000,000 cP; in some embodiments, the feed compositions of the invention have viscosity of about 50,000 cP to 3,000,000 cP, or about 100,000 P to 2,000,000 cP, or about 200,000 cP to 1,000,000 cP, or about 500,000 cP to 3,000,000 cP, or about 1,000,000 to 4,000,000 cP, or about 2,000,000 cP to 4,000,000 cP. In some embodiments, the viscosity of the paste feed compositions of the invention varies less than about 50% between 20° C. and 50° C., for example the viscosity varies less than about 40% between 20° C. and 50° C., or less than about 30% between 20° C. and 50° C., or less than about 25% between 20° C. and 50° C., or less than about 20% between 20° C. and 50° C., or less than about 10% between 20° C. and 50° C. In some embodiments, the paste feed compositions of the invention have a Newtonian viscosity profile. In other embodiments, the paste feed compositions of the invention are thixotropic or pseudoplastic. In some embodiments the In some embodiments, the paste feed compositions of the invention include a viscosifier wherein the viscosifier exhibits hysteresis. The viscosity profile of the paste feed composition is primarily dictated by the type and amount of the viscosifier employed in the composition, but in some embodiments is strongly influenced by the food components of the composition, the pH of the composition, or both. In some embodiments the paste feed compositions include combinations of two or more viscosifiers. It will be understood that where “viscosifier” is employed in the singular, it also includes the plural where allowed by context.

The ratios of the components usefully employed in the paste feed compositions of the invention are not particularly limited and will depend on the targeted animal species, nature of the environment encountered, and type of food and viscosifier components employed as well as pH and interaction of components in the final composition. In some embodiments, the amount of viscosifier employed is between about 0.001 weight percent (wt %) to 5 wt % of the composition, for example about 0.005 wt % to 3 wt %, or about 0.01 wt % to 2 wt %, or about 0.05 wt % to 1 wt %, or about 0.005 wt % to 1 wt %, or about 0.01 wt % to 0.5 wt %, or about 0.005 wt % to 0.5 wt %, or about 0.01 wt % to 0.1 wt %. In some embodiments, the amount of water in the paste feed composition is about 10 wt % to about 50 wt %, or about 15 wt % to 40 wt %, or about 20 wt % to 30 wt %. The food components, plus any adjuvants added, make up the balance of the paste feed compositions.

In some embodiments, the paste feed compositions include citric acid as a component thereof. It is a feature of the invention that citric acid is employed as a palatability additive for some animals. Further, where citric acid or another acid is included as part of the paste feed compositions of the invention, a separate component, added to the paste by the end user just prior to application, is sodium bicarbonate. Addition of sodium bicarbonate to citric acid forms sodium citrate and carbon dioxide in situ, which causes the paste to foam as is described above in detail.

Method of Making

The paste feed compositions are easy to make employing known industrial techniques and equipment. Both batch and continuous modes of manufacturing are advantageously employed by those having skill. In some embodiments, a slurry is formed prior to forming the paste feed composition. A slurry is formed when at least one of the food components and a viscosifier are combined with water but the viscosity is not yet elevated to its final selected end point. In some embodiments, the dry ingredients, which include in some embodiments the food component(s), viscosifier, and any adjuvants, are blended together, followed by addition of water to the dry ingredients to form a slurry. In other embodiments, one or more dry ingredients are added directly to water to form a slurry.

In some embodiments, slurry formation is followed by addition of heat, wherein the amount of heat added is sufficient to cause the viscosifier to raise the viscosity of the slurry to a selected end point; this is also called “set up”. Heating the slurry includes adding heat sufficient to raise the temperature to about 30° C. to 100° C., or even above 100° C. if the vessel containing the slurry is enclosed such that pressure is suitably applied. The amount of time during which heat is applied is determined by the type and amount of viscosifier added and the nature of the processing involved, e.g. batch vs. continuous mode, size of a batch etc. In other embodiments, no heat is added and the viscosifier imparts an elevated viscosity to the slurry upon wetting and fully hydrating the viscosifier. In still other embodiments, the slurry is formed, then heated, but set up does not occur until cooling of the paste feed composition to a lower temperature, such as between 0° C. and 50° C., or about 10° C. and 45° C., or about 20° C. and 40° C. In some such embodiments, it is advantageous to package the paste feed composition either before heating, or while the heated composition is still at a temperature above the temperature where set up is observed.

In some embodiments, a method of making a paste feed attractant includes mixing a sugar-containing product with water in a vessel to form a sugar containing solution; adding one or more viscosifiers to the sugar containing solution to form a slurry; mixing additional food components comprising a grain component and a plant-derived oil component into the slurry; heating the slurry to form a feed composition; removing the heat source from the feed composition; and pouring the feed composition from the vessel into two or more containers; wherein upon cooling to a selected temperature, the feed composition sets up to form a paste having a selected viscosity. The selected temperature and viscosity will depend on the type and amount of viscosifier, or blend thereof, employed in the composition.

In some embodiments the paste feed composition of the invention is formed as a masterbatch, and the masterbatch is subsequently packaged for individual use. A masterbatch is a batch composition having a volume of greater than about 20 liters, wherein the volume is not particularly limited as to upper range of size and could include e.g. a tanker or truckload. The masterbatch is packaged for shipment and/or storage. In some embodiments where heat is employed to cause set up, the slurry is formed in masterbatches, wherein the blending of the masterbatch does not employ the addition of heat. At a selected time, the masterbatch is heated as a single batch, as part of a continuous process, or by breaking the masterbatch into several small batches. The heat added to the masterbatch is sufficient to cause the composition to set up upon heating or upon subsequent cooling. Before heating, or after heating but prior to setup, the masterbatch is divided into smaller batches or individual containers.

The individual containers having the paste feed composition of the invention contained therein are intended for an end user to carry to a selected location and apply the paste feed composition to the selected surface. Thus, the individual containers hold about 1 mL to 10 liters, or about 100 mL to 5 liters, or about 500 mL to 1 liter of the paste feed composition. In some embodiments, the individual containers are cups or buckets, with lids that are removable and reusable. In some embodiments, the individual containers are elongated cylindrical tubes having a nozzle on one end and a movable plunger on the other end, wherein the tube is adapted for use with a caulk gun type apparatus. In some embodiments, the individual container is a toothpaste tube having a collapsible body and a removable and reusable cap that is snapped on or screwed on. In some embodiments, the individual container is a sealed sleeve formed from a thermoplastic film, such as polyethylene, polypropylene, or polyester film, and the film is adapted to be cut open on one end and the feed composition urged out of the tube by the end user collapsing the tube on the end opposite from the cut end.

In some embodiments, the feed composition components are blended and heated in a single batch or in a continuous process and are loaded directly into individual containers. In some embodiments, rather than employ a masterbatch, the individual containers are filled with the feed composition directly. In some embodiments where heat is required to bring out set up, the containers are filled prior to heating, and the heating is carried out in the individual container.

In some embodiments, the feed composition is added to a medium other than an individual container for an end user to use. For example, in some embodiments where the feed composition will be used for animal enrichment, the feed composition is tumbled or mixed with a medium such as hay, woven or nonwoven fabric, sticks, wood fibers, plastic netting or mesh, and the like, to disperse the feed composition within the medium. In some such embodiments, the paste feed composition is heated to cause set up prior to mixing with the medium. In other such embodiments, the slurry composition is mixed with the medium and then the combined composition and medium is heated to cause set up.

Method of Using

It is a feature of the present invention that the paste feed composition is easy to use by an end user. The viscosity of the composition is sufficient to prevent gravity-assisted flow at temperatures as high as 50° C. to 85° C., or 60° C. to 80° C., or 65° C. to 75° C., or 50° C. to 70° C., yet the composition is easily applied to a variety of surfaces by use of shear or extension force applied by a user. As discussed above, in some embodiments the paste feed composition includes a viscosifier that is pseudoplastic; in some such embodiments, shear applied by the end user during application is sufficient to cause significant thinning of the composition, making it easy to work and apply. The pseudoplastic property also causes the composition to “set up” again immediately upon cessation of the shear force, so that the composition stays in the selected location even on vertical surfaces.

Where the end user employs a cup, squeezable tube, or bucket of the composition, a paint mixing stick, spatula, knife, scoop, spoon, brush, or roller, or two or more of these are useful to meter out portions of the composition and spread it onto the selected surface. The feed composition is applied to the selected surface in any desired amount. Very thin layers, for example 1 mm or less, are applied to a selected surface in some embodiments. Thick or layers, greater than 1 mm and up to any desired thickness, for example about 2 mm to 10 cm, or about 2 mm to 5 cm, or about 2 mm to 1 cm are easily applied with ease to any selected surface.

The selected surface may be horizontal, vertical, or anywhere in between. If desired, the feed composition can be worked into the crevice of a knothole of a tree, into the gaps and crevices between rough or peeling bark and a tree trunk, into crevices between rocks or into pits, cracks, fissures, or other natural features in rocks, into the crotch of a tree branch point, or into some portion of a man-made apparatus. It is a feature of the invention that the feed composition is easily applied to, and worked into, crevices, cracks, convolutions, folds, and other surface features where liquids would flow easily but subsequently would flow out, wherein the feed compositions do not subsequently flow out. The paste-like viscosity of the feed compositions provides for ease of application while providing a viscosity suitable to retain the feed composition in the location selected by the end user.

In some embodiments where the feed composition is a foam paste composition, the foaming action further serves to force the composition into gaps, crevices, and the like. In some embodiments, the foam paste compositions are added to the interior of a tree trunk, a man made vessel, or the like, wherein the animal is unable to reach it as applied; and the foaming action of the foam paste composition serves to dispense the composition from the unreachable area. In some such embodiments, a slow rate of foaming is desirable.

In one method, a feed composition of the invention is used to establish a pattern of behavior in a wild or semi-wild animal wherein the animal is conditioned to return to a selected spot on a repeated basis. A wild animal is an animal that is not conditioned to accept or expect human interaction. A semi-wild animal is an animal that has been conditioned to accept or expect limited human interaction, for example bottle-feeding, hand feeding, and the like. The feed compositions of the invention are useful to establish such behavior patterns in wild or semi-wild animals in open, semi-enclosed, or large enclosed areas. A semi-enclosed area is an area that includes one or more fenced regions wherein the fenced regions are not fully enclosed. Typically, but not always, the fenced areas in a semi-enclosed area describe land areas larger than 1 acre, and up to 10 acres, or up to 100 acres, or up to 1000 acres, or even larger. Enclosed areas are small in some embodiments, for example between about 1 acre and 10 acres, and are large in other embodiments, for example about 100 acres up to 1,000 acres, or 10,000 acres, or 100,000 acres or more.

In some embodiments, the targeted area is an enclosed area that is stocked with a selected type of animal, for example for hunting purposes. In one representative example, an enclosed area including about 1000 acres of land may have 1000 or more semi-wild deer stocked within the area. In other embodiments the targeted area is an open area where the targeted wild animal is scarce. In one representative example, in open area of about 1000 ac.² includes between 1 and 10 wild deer. In yet some other embodiments, the targeted area is a semi-enclosed area that is set up to concentrate a wild population of an animal and limit their movement once within the boundaries of the partial enclosure. An unlimited number of combinations of land and enclosure sizes and types, together with animal type, nature, and extent of proliferation exist, as will be appreciated by one of skill. It is a feature of the invention that all such combinations are addressed using the paste feed compositions of the invention to a greater extent than with previous food attractants, because of the durability of the paste feed compositions when applied at one or more selected locations.

Thus, in various embodiments, a location is selected and within the targeted location a surface is selected. In embodiments, suitable surfaces include the surfaces or portions of surfaces of fallen trees, logs, or branches, including the spaces or crevices between rough or peeling bark and the main body of the tree, log, or branch; tree trunks or branches or portions thereof, including the spaces or crevices between rough or peeling bark and the main portion of the trunk or branch or portion thereof; rocks or crevices between rocks; man-made devices for hiding food, such as puzzle feeders, devices having artificial folds, creases, crevices, narrow channels, and the like; or a combination of two or more of these. A paste feed composition of the invention is applied to the selected surface by the end user using any of the methods described above, in a selected amount and a selected thickness as described above.

Once applied to the selected surface, certain advantages of the paste feed compositions of the invention become apparent. First, the feed compositions of the invention do not flow, drip, melt, or sag. The compositions of the invention remain on the selected surface as applied until consumed, regardless of seasonal temperatures. The paste will not melt, flow, or sag even when placed in direct sunlight at temperatures as high as 50° C. or more, in some embodiments as high as 85° C. This advantage prevents loss of the product during warm days and in direct sunlight.

Second, the feed compositions of the invention remain as applied within cracks, crevices, convolutions, folds, pits, and the like within a selected surface and do not flow out, thereby providing the possibility of longer-term attraction for the targeted animals. Whereas conventional food attractants would be quickly eaten by the targeted animal due to the availability thereof, some portion of the feed compositions of the invention can be made to remain at the selected location for days or even weeks after application to the selected surface, because the animal cannot reach it and the composition does not flow out. In some embodiments, even where the majority of the actual food product has been consumed, there is a sufficient amount of the feed composition residing within one or more cracks, crevices, and the like to attract the targeted animal via the odor thereof.

Third, the paste feed compositions of the invention have been observed to have good wash-off resistance to rain. For example, the compositions withstand driving rain for about 5 minutes up to about an hour; less severe dousing result in hours or even days of wash-off resistance. Standard feeds based on molasses, for example, withstand only 1-2 minutes of driving rain.

Fourth, the paste feed compositions can be made to foam, wherein the high viscosity of the paste gives rise to the slow eruption of the carbon dioxide filled bubbles that form from the reaction of sodium bicarbonate with one or more acids or other sources of hydronium ion in the paste feed compositions. The bubbles provide an increased amount of surface area to disperse the scent of the food attractant, including any other potentially attractant scent added to the paste feed composition (e.g. urine, estrous, other pheromone), from the selected location where the paste feed composition is applied. In some embodiments the foaming action also provides an additional means to force the paste feed composition into the cracks, crevices, etc. where the animals cannot reach it, thereby increasing longevity of the food attractant still further.

The cumulative effect of these advantages is durability of the paste feed compositions of the invention. The ability to fill uneven and hard-to-reach surfaces found in nature with palatable food attractant, coupled with the ability to avoid flow of the compositions after placement, plus resistance to high temperatures and rain, gives rise to durability in the face of determined animals. Durability of the compositions, coupled with the natural urge to forage by the targeted animals, enables use of the paste feed compositions to obtain animal behavior modification with superior results. Establishing a pattern of behavior in a targeted animal in an open, semi-enclosed, or large enclosed area is accomplished with ease, since the paste feed compositions provide a durable source of attraction. The animals are drawn to the site repeatedly by the attractant that continues to reside within crevices, cracks, or other uneven surface features days and even weeks after initial application. Replenishment on a daily or semi-daily basis is not required.

In enrichment applications, the paste feed compositions' durability means a longer lasting enrichment experience for the animal. Further, the ability in some cases to trigger set up by heating enables certain enrichment combinations to be made with ease. For example, hay or other media are easily tumbled or mixed with a slurry of the composition prior to heating, when viscosity is low; the mixture of the slurry in the media is then heated to trigger set up. In this manner, a combination of a media evenly coated with the paste feed composition is easily made. Such coated media may be provided directly for enrichment purposes, or may further be provided in e.g. a puzzle feeder or some other device for the animal to use in an enrichment activity.

In some embodiments, the paste feed compositions act to attract or enrich the targeted animal for about 1 to 30 days after application to the selected location, for example about 2 to 25 days after application, or about 2 to 20 days after application, or about 2 to 15 days after application, or about 2 to 12 days after application, or about 2 to 10 days after application, or about 2 to 25 days after application, or about 4 to 25 days after application, or about 7 to 25 days after application, or about 10 to 25 days after application, or about 15 to 25 days after application, or about 15 to 21 days after application.

In some embodiments, the targeted animal is a ruminant mammal of the family Cervidae, including white-tail deer, mule deer, black-tail deer, elk moose, red deer, caribou, fallow deer, roe deer, pudú, or chital. In some embodiments, the targeted animal is a wild boar or wild pig (Sus scrofa), a species of the pig genus Sus, part of the biological family Suidae. Wild boar are native across much of Northern and Central Europe, the Mediterranean region, and much of Asia; however, populations have also been artificially introduced in other parts of the world, including the Americas, and in some cases have become established after escapes of wild boar from captivity. In still other embodiments, the targeted animal is a game bird, such as wild turkey, pheasant, quail, and various goose or duck species.

In some embodiments, the paste feed composition of the invention is used to establish a pattern of returning behavior in a wild or semi-wild ruminant mammal of the family Cervidae, wherein 1 to 1000 animals, or 10 to 500 animals, or 10 to 100 animals, or 1 to 25 animals, or 1 to 10 animals are conditioned to return to the selected location having the paste feed composition applied thereto on a repeated basis after 1 application of the paste feed composition, or after 1 to 2 applications, or after 1 to 5 applications, or after 2 to 5 applications to the selected location. In some embodiments the “selected location” is a single point location, that is, a single selected surface; in other embodiments, it is between 2 and 10 selected surfaces within a 1 mile radius, or 2 to 100 selected surfaces within a 1 mile radius. In some such embodiments, the selected location is an open, semi-enclosed, or large enclosed area.

### EXAMPLES

The following examples are illustrative of the paste feed compositions of the invention. Additional examples and variations will be apparent to those of skill.

The components shown in Table 1 were admixed in a vessel by hand, at the indicated weight ratios to provide a Base Feeding Mixture 1 (“Base 1”).

TABLE 1
Base Feeding Mixture 1, or “Base 1”

| | |
|---|---|
| Cane Molasses | 53.07 |
| Water | 22 |
| Rice bran | 20 |
| Salt | 2.5 |
| Citric acid | 1 |
| Attapulgite clay | 0.6 |
| Propionic acid | 0.5 |
| Crude soybean oil | 0.1 |
| Molasses flavor | 0.1 |
| Trace vitamins and minerals | 0.08 |
| Tetrasodium Pyrophosphate | 0.03 |
| Xanthan Gum | 0.02 |

The components shown in Table 2 were admixed in a vessel by hand, at the indicated weight ratios to provide a Base Feeding Mixture 2 (“Base 2”).

TABLE 2
Base Feeding Mixture 2, or “Base 2”

| | |
|---|---|
| Molasses | 52.10 |
| Water | 21 |
| Rice bran | 22 |
| Salt | 3 |
| Citric acid | 1 |
| Attapulgite clay | 0.6 |
| Propionic acid | 0.5 |
| Crude soybean oil | 0.1 |
| Molasses flavor | 0.1 |
| Trace vitamins and minerals | 0.07 |
| Tetrasodium Pyrophosphate | 0.03 |
| Xanthan Gum | 0.02 |

### Example 1

Agar RS-100 (powder, Kosher) was obtained from TIC Gums, Inc. of White Marsh, Md. and used as is. A mixture of 98 g Base 1 and 2 g agar was mixed by hand, then heated to boiling in a microwave oven, stopping to re-mix several times during heating. Then the mixture was allowed to stand and cool to ambient temperature. A very firm, block-like composition resulted.

### Example 2

The procedure of Example 1 was repeated, except with 99.95g base and 0.05g agar. A thick paste resulted. The viscosity was measured as 123,000 cP (1230 Poise) using a Brookfield DIV-III+ rheometer (obtained from Brookfield Engineering Laboratories of Middleboro, Mass.) using a #7 spindle at 20 rpm.

### Example 3

The procedure of Example 2 was repeated, except that the mixture was not heated. The mixture remained fluid. After a week, the viscosity of the mixture had not changed.

### Example 4

Base 2 was added to a 5-gallon steam-jacketed GROEN® kettle mixer (obtained from Chef Mart Restaurant Supply Inc. of Houston, Tex.). Agar (0.05 wt % based on the Base 2) in soybean oil was added and allowed to mix for 1 minute. The product was then heated to 88° C. (190° F.) using steam, then was immediately poured into 1-gallon buckets. The temperature rose after the steam was turned off and was measured at 95° C. (203° F.) in the buckets. As it cooled, the liquid was observed to thicken to paste-like consistency.

Brookfield viscosity at 22° C. for the mixture of Example 4 was 145,000 cP (1,450 P) using #7 spindle at 20 rpm.

### Examples 5-7

A 5 gallon steam-jacketed GROEN® kettle mixer (obtained from Chef Mart Restaurant Supply Inc. of Houston, Tex.) was charged in the indicated order and indicated mixing times as shown in Table 3 for each of Examples 5-7 in turn. The Example 5 mixture was heated to 82° C. (180° F.). The Examples 6 and 7 mixtures were heated to at least 87° C. (188° F.), according to the thermocouple provided with the apparatus, but appeared to be boiling near the interface with the steam jacket. Examples 6 and 7 were noticeably thicker than Example 5 after cooling to ambient temperature.

TABLE 3
Components and blending order for Exs. 5-7.

| | Ex. 5 | Ex. 6 | Ex. 7 |
|---|---|---|---|
| Component | Wt % | Wt % | Wt % |
| Molasses | 51.535 | 50.335 | 49.535 |
| Water | 21.0 | 21.0 | 21.0 |
| Tetrasodium Pyrophosphate | 0.03 | 0.03 | 0.03 |
| Attapulgite clay | 0.6 | 0.6 | 0.6 |
| Mix 3 minutes | | | |
| Soy oil | 0.6 | 0.6 | 0.6 |
| Xanthan gum | 0.02 | 0.02 | 0.02 |
| Agar | 0.1 | 0.1 | 0.1 |
| Blend above together | | | |
| Mix 3 minutes | | | |
| Salt | 2.5 | 2.5 | 2.5 |
| Citric acid | 1.0 | 1.0 | 1.0 |
| Propionic acid | 0.5 | 0.5 | 0.5 |
| Molasses Flavor | 0.1 | 0.1 | 0.1 |
| Trace minerals and vitamins | 0.12 | 0.1 | 0.1 |
| Rice Bran | 22.0 | 22.0 | 22.0 |
| Peanut paste | | 1.0 | 1.0 |
| Peanut flavor | | 0.20 | 1 |
| Mix 3 minutes | | | |
| TOTAL | 100.0 | 100.00 | 100.0 |

### Example 9

The components listed in Table 4 were combined and blended in a 5 gallon steam-jacketed GROEN® kettle mixer (obtained from Chef Mart Restaurant Supply Inc. of Houston, Tex.) in the indicated order using the indicated mixing times as shown. Locust bean gum POR/A2 and xanthan gum were obtained from TIC Gums, Inc. of White Marsh, Md. and used as is.

TABLE 4
Components and blending order for Ex. 9.

| Component | Wt % |
|---|---|
| Molasses | 51.690 |
| Water | 21.00 |
| Tetrasodium pyrophosphate | 0.03 |
| Attapulgite clay | 0.40 |
| Mix 3 minutes | |
| Soy oil | 0.60 |
| Xanthan gum | 0.015 |
| Locust bean gum | 0.05 |
| Mix 3 minutes | |
| Salt | 2.50 |
| Citric acid | 1.00 |
| Propionic acid | 0.50 |
| Rice Bran | 22.00 |
| Trace vitamin and mineral mix | 0.22 |

Heat to 93° C.; mix 3 minutes

Either 50 grams of cane molasses or 50 grams of the mixture indicated in Table 4 (after cooling to ambient laboratory temperature) were placed on a fiberglass cafeteria type tray at ambient laboratory temperature. Both samples were about 3″ diameter and ¼″ thick on the tray. The tray was sprayed constantly with cold water from a spray from a kitchen type faucet to simulate heavy, driving rain. Time to wash off the product was recorded. The molasses was completely washed off after 80 seconds. After 800 seconds, about 32% of the composition of Table 4 remained on the tray.

### Example 10

The components listed in Table 5 were combined and blended in a 5 gallon steam-jacketed GROEN® kettle mixer (obtained from Chef Mart Restaurant Supply Inc. of Houston, Tex.) in the indicated order using the indicated mixing times as shown. Locust bean gum POR/A2 and xanthan gum were obtained from TIC Gums, Inc. of White Marsh, Md. and used as is.

TABLE 5
Components and blending order for Ex. 10.

| Molasses | 10338 | g |
|---|---|---|
| Water | 4200 | g |
| Tetrasodium pyrophosphate | 6 | g |
| Attapulgite clay | 80 | g |
| Mix 3 minutes | | |
| Soy oil | 120 | g |
| Xanthan gum | 3 | g |
| Locust bean gum | 10 | g |
| Mix 3 minutes | | |
| Salt | 500 | g |
| Citric acid | 200 | g |
| Propionic acid | 100 | g |
| Rice Bran | 4400 | g |
| Trace vitamin and mineral mix | 50 | g |

Then the mixture of Table 5 was heated to 93° C. (200° F.) and mixed for another 3 minutes. The mixture was then dispensed from the mixer and allowed to cool to ambient temperature.

At 21° C. the Brookfield viscosity of the composition was 1.75×10⁶ cP using a #7 spindle at 2 rpm (noting that 2 rpm is below the specified range of use). The mixture was heated to 38° C. and the viscosity was 1.30×106 cP using a #7 spindle at 2 rpm.

Although the present disclosure provides references to preferred embodiments, persons skilled in the art will recognize that changes may be made in form and detail without departing from the spirit and scope of the invention. The invention illustratively disclosed herein can be suitably practiced in the absence of any element which is not specifically disclosed herein. While the invention is susceptible to various modifications and alternative forms, specifics thereof have been shown by way of examples, and are described in detail. It should be understood, however, that the invention is not limited to the particular embodiments described. On the contrary, the intention is to cover modifications, equivalents, and alternatives falling within the spirit and scope of the invention. Additionally each and every embodiment of the invention, as described here, is intended to be used either alone or in combination with any other embodiment described herein. In various embodiments, the invention suitably comprises, consists essentially of, or consists of the elements described herein and claimed according to the claims.

1. A method of establishing a pattern of returning behavior in a wild or semi-wild ruminant mammal of the family Cervidae, the method comprising:
applying a paste feed composition to one or more selected surfaces within a selected location, the paste feed composition comprising about 0.01 wt % to 5 wt % of a viscosifier, and about 10 wt % to 50 wt % water;
wherein the viscosity of the composition is about 10,000 to 5,000,000 cP between 20° C. and 50° C.; and
wherein 1 to 1000 animals are attracted to the selected location having the paste feed composition applied thereto.

2. The method of claim 1 wherein the paste feed composition is applied to the one or more selected surfaces a sufficient number of times sufficient to establish the pattern of returning behavior.

3. The method of claim 2 wherein the paste feed composition is applied to the one or more selected surfaces between 1 and 5 times.

4. The method of claim 2 wherein the edible composition is placed at the one or more locations over a selected period of time, the selected period of time extending for at least one week.

5. The method of claim 4 wherein the selected period of time ends before the start of the hunting season or at the start of a hunting season for the Cervidae.

6. The method of claim 1 wherein the selected location comprises between 2 and 100 selected surfaces.

7. The method of claim 1 wherein the selected location is an open, semi-enclosed, or large enclosed area.

8. The method of claim 1 wherein the animals are attracted to the selected location for about 1 to 30 days after an application of the paste feed composition.

9. A paste feed composition comprising a food attractant, about 0.01 wt % to 5 wt % of a viscosifier, and about 10 wt % to 50 wt % water, wherein the viscosity of the composition is about 10,000 cP to 5,000,000 cP between 20° C. and 50° C.

10. The composition of claim 9 wherein the viscosifier comprises agar, xanthan gum, locust bean gum, carrageenan, or a combination of two or more thereof.

11. The composition of claim 9 wherein the food attractant comprises a sugar-containing product, a grain component, and a plant-derived oil component.

12. The composition of claim 9 wherein the composition comprises citric acid.

13. The composition of claim 9 wherein the composition further comprises one or more pheromones, animal extracts, vitamins, salts, minerals, Maillard reaction products of one or more sugars and proteins, or a combination thereof.

14. The composition of claim 9 wherein the viscosity of the composition varies less than about 50% between about 20° C. and 50° C.

15. An article comprising the paste feed composition of claim 9, wherein the article is a tree, a log, a branch, a rock, or a combination of two or more thereof that are present outdoors.

16. The article of claim 15 wherein the article attracts or enriches a targeted animal for about 1 to 30 days.

17. The article of claim 16 wherein the targeted animal is a wild or semi-wild ruminant mammal of the family Cervidae or an animal in an enclosure.

18. A method of making a paste feed attractant, the method comprising:
mixing a sugar-containing product with water in a vessel to form a sugar containing solution;
adding agar, xanthan gum, locust bean gum, carrageenan, or a combination of two or more thereof to the sugar containing solution to form a slurry;
mixing additional food components comprising a grain component and a plant-derived oil component into the slurry;
heating the slurry to between 40° C. and 100° C. to form a feed composition; and
removing the heat source from the feed composition,
wherein upon reaching a temperature of about 20° C. to 50° C. the feed composition sets up to form a paste having a viscosity of about 10,000 cP to 5,000,000 cP.

19. The method of claim 18 further comprising pouring the slurry with the additional food components mixed therein into two or more containers prior to the heating or pouring the feed composition into two or more containers after removing from the heat source but prior to set up.

20. A method of providing enrichment for an animal in an enclosure, the method comprising introducing an article into the enclosure, the article comprising a puzzle feeder, a toy, hay or a hay stack, woven or nonwoven fabric, a stick, wood fibers, plastic netting or mesh, a tree, a log, a branch, a rock, or a combination of two or more thereof, wherein the article comprises a composition of claim 9.
